(19) United States
(12) Patent Application Publication
(10) Pub. No.: US 2014/0208876 A1
(43) Pub. Date: Jul. 31, 2014

(54) SENSORS WITH MODULAR THREADED PACKAGING

(71) Applicant: Meggitt (Orange County), Inc., Irvine, CA (US)

(72) Inventor: Margie Mattingly, San Clemente, CA (US)

(73) Assignee: Meggitt (Orange County), Inc., Irvine, CA (US)

(21) Appl. No.: 14/162,361

(22) Filed: Jan. 23, 2014

Related U.S. Application Data
(60) Provisional application No. 61/757,864, filed on Jan. 29, 2013.

(51) Int. Cl. G01D 11/30

(52) U.S. Cl. CPC G01D 11/30
USPC 73/866.5; 29/25.35

(57) ABSTRACT

A modular piezoelectric sensor system, wherein the system comprises: a sensor pod including at least one standard sensor interface; and a plurality of different mounting adapters that include different external mounting interfaces wherein each mounting adapter has at least one complementary standard sensor interface.

### RELATED APPLICATIONS

This application claims priority to U.S. Provisional Patent Application No. 61/757,864, filed Jan. 29, 2013, and entitled “IEPE Sensors with Modular Threaded Packaging,” which is incorporated herein by reference.

### FIELD

The present patent document is directed generally to sensor pods, and more particularly, to sensor pods with a versatile threaded housing.

### BACKGROUND

Piezoelectric (PE) sensors have proven to be versatile tools for the measurement of various processes. They are used for quality assurance, process control, and research and development in many different industries. Although the piezoelectric effect was discovered by Pierre Curie in 1880, it was only in the 1950s that the piezoelectric effect started to be used for industrial sensing applications. Since then, this measuring principle has been increasingly used and can be regarded as a mature technology with an outstanding inherent reliability. It has been successfully used in various applications, such as in medical, aerospace, and nuclear instrumentation, and as a pressure sensor in the touch pads of mobile phones. In the automotive industry, piezoelectric elements are used to monitor combustion when developing internal combustion engines. The sensors are either directly mounted into additional holes into the cylinder head or the spark/glow plug is equipped with a built in miniature piezoelectric sensor.

The rise of piezoelectric technology is directly related to a set of inherent advantages. The high modulus of elasticity of many piezoelectric materials is comparable to that of many metals and goes up to 106 N/m. Even though piezoelectric sensors are electromechanical systems that react to compression, tension and/or shear forces, the sensing elements show almost zero deflection. This is the reason why piezoelectric sensors are so rugged and have an extremely high natural frequency and an excellent linearity over a wide amplitude range. Additionally, piezoelectric technology can be made insensitive to electromagnetic fields and radiation, enabling measurements under harsh conditions.

Generally, subassemblies are permanently epoxied or welded into a particular mounting configuration at the sensor manufacturer, which requires many model numbers to be purchased to accommodate all potential measurement requirements.

There is a need for a modular and field interchangeable means, threads, twist-lock, and the like, that enables the coupling and mounting of sensing elements (pods) into the base for various mountings and allows the end user to make the sensor needed. There is a further need for lower cost products whereby an economy of scale/volume is created by using interchangeable components. Yet another need is reduced lead times and an ability to run larger batches. There is also a need for fewer model number specific parts to forecast. In addition, there is a need for offering versatility and flexibility to the customer by accommodating various vibration environments. There is a further need to allow the end user to construct what is needed for their measurement from pods and mounting bases or directly embed/integrate pods directly into the structure being measured.

### SUMMARY OF THE INVENTION

One object of the embodiments of the present patent document is to provide an improved sensor pod. A further object of the embodiments of the present patent document is to provide a sensor pod that allows the end user to construct what is needed for their measurement from pods and mounting bases/adapters. To this end, a system for installing a piezoelectric sensor is provided. In one embodiment, the system comprises: a sensor pod including at least one standard sensor interface; a plurality of different mounting adapters that include different external mounting interfaces and each mounting adapter has at least one complementary standard sensor interface.

In another embodiment, the system further comprises a plurality of sensor pods with the same standard sensor interface wherein different sensor pods are capable of measuring different output sensitivities. In some of those embodiments, the output sensitivities range from 1 to 1000 mV/g.

In some embodiments, at least one of the mounting adapters is shaped like a block. In some embodiments, at least one of the mounting adapters has a hexagonal interface. In additional embodiments, at least one of the mounting adapters is designed to hold more than one sensor pod. In embodiments with more than one sensor pod, at least one of the mounting adapters may be designed to hold three sensor pods in a triaxial configuration.

Different embodiments may support different sensor designs or different sensor designs may be included in the same embodiment. In some embodiments, the sensor pod has an IEPE sensor design. In other embodiments, the sensor pod has a PE sensor design. In yet other embodiments, both sensor designs are built with the same standard sensor interface and are interchangeable within the mounting system.

In another aspect of the present patent document, a system for installing piezoelectric sensors is provided. In some embodiments, the system comprises: a plurality of sensor pods with varying sensitivities wherein each sensor pod includes at least one standard sensor interface; and a mounting adapter with an external mounting interface and at least one complementary standard sensor interface. In some embodiments, the system further comprises a plurality of different mounting adapters that include different external mounting interfaces wherein each mounting adapter has at least one complementary standard sensor interface.

In some embodiments, the output sensitivities range from 1 to 1000 mV/g. In other embodiments, the output sensitivities may range from 1 to 25 pC/g. In some embodiments, the mounting adapter has a hexagonal external interface. In some embodiments, the mounting adapter is designed to hold more than one sensor pod. And in some of those embodiments, the mounting adapter is designed to hold three sensor pods in a triaxial configuration.

In another aspect of the present patent document, a method of providing a plurality of piezoelectric sensors with different mounting interfaces is provided. In a preferred embodiment, the method comprises: manufacturing a plurality of sensor pods each with the same standard sensor interface; and manufacturing a plurality of mounting adapters with different external interfaces but each with a complementary standard sensor interface.

In some embodiments of the method, the plurality of sensor pods includes sensor pods with varying sensitivities. In some embodiments, the plurality of sensor pods includes sensor pods designed to detect different measurable effects.

In the preferred embodiment, a sensor pod with a versatile threaded housing is provided. The threaded sensor pod with threads for various mountings allows the end user to make the sensor needed. The sensor pod may allow for lower cost products by creating an economy of scale and volume through the use of interchangeable components. The sensor embodiments of the present patent document may also enable reduced lead times and an ability to run larger batches. In addition, the number of model specific parts to forecast may be reduced. The embodiments disclosed herein provide a sensor pod that offers versatility and flexibility to the customer in accommodating various vibration environments.

Further aspects, objects, desirable features, and advantages of the devices and methods disclosed herein will be better understood from the detailed description and drawings that follow in which various embodiments are illustrated by way of example. It is to be expressly understood, however, that the drawings are for the purpose of illustration only and are not intended as a definition of the limits of the claimed invention.

### BRIEF DESCRIPTION OF THE DRAWINGS

FIG. 1 illustrates an isometric view of one embodiment of a sensor pod.

FIG. 2 illustrates an isometric view of another embodiment of a sensor pod.

FIG. 3 illustrates an isometric view of a mounting adapter for use with the sensor pods of FIGS. 1 and 2.

FIG. 4 illustrates an isometric view of one embodiment of a system comprising a sensor pod and a mounting adapter.

FIG. 5 illustrates an isometric view of one embodiment of a system for installing a piezoelectric sensor comprising a pod and a mounting adapter.

FIG. 6 illustrates an isometric view of one embodiment of a sensor system including a mounting adapter designed to hold multiple sensor pods in different axes.

FIG. 7 illustrates an isometric view of one embodiment of a sensor system including a mounting adapter designed to hold multiple sensor pods along the same axes.

FIG. 8 illustrates a system with a mounting adapter with diverse components mounted to it.

### DETAILED DESCRIPTION OF THE PREFERRED EMBODIMENTS

The embodiments of the present patent document appreciate the advantages of breaking the construction of piezoelectric sensors up into at least two parts. The first part is the sensor itself, which is adapted with at least one of a plurality of standard sensor interfaces. The sensor including at least one of a plurality of standard sensor interfaces may be referred to as a “pod” or “sensor pod.” The second part is the mounting adapter. The mounting adapter contains at least one complementary standard interface, such that the sensor pod may be easily attached to the mounting adapter. The mounting adapter may take on any shape or form to allow the assembly of the sensor pod/mounting adapter to be installed into the next higher assembly. By standardizing the sensor interface, different types of sensors may be easily mounted into mounting adapters allowing for increased flexibility and easier manufacturing.

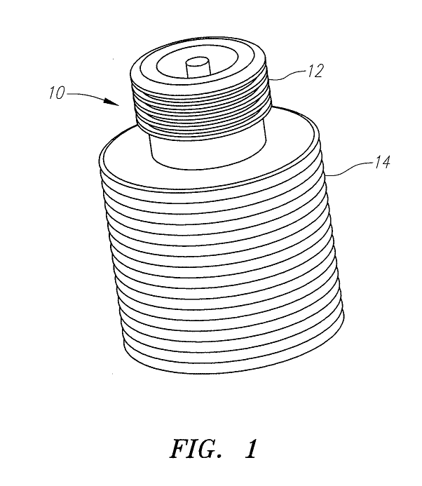

FIG. 1 illustrates one embodiment of a sensor pod 10. In the embodiment shown in FIG. 1, the sensor pod 10 includes a standard sensor interface 14 and an electrical interface 12. Standard sensor interface 14 is designed to be consistent across a number of different sensor pods 10. Standard sensor interface 14 is designed to mate with a plurality of different mounting adapters.

In the embodiment shown in FIG. 1, the sensor is comprised of a piezoelectric sensing assembly, with or without integral electronics, contained within a threaded housing. In the embodiment shown in FIG. 1, the sensor output is taken from a connector 12 that provides an electrical interface to the sensor pod 10. In other embodiments, the sensor output may be communicated from the sensor pod 10 using other types of interfaces including a wireless interface.

In the embodiment shown in FIG. 1, the standard sensor interface 14 is a threaded housing. In a preferred embodiment, the threads of the standard sensor interface 14 comply with a thread standard such as UNC, UNF, various metric thread standards, or any other thread standard. As a non-limiting example, the sensor pod 10 may include a standard sensor interface 14 with male ½-UNF-2B threads. In a preferred embodiment, the standard sensor interface 14 covers a majority of the outside of the sensor pod 10. Preferably, the standard sensor interface is on the exterior of the main housing of the sensor pod 10. This provides robustness and allows the sensor pod to be installed within an upper level assembly.

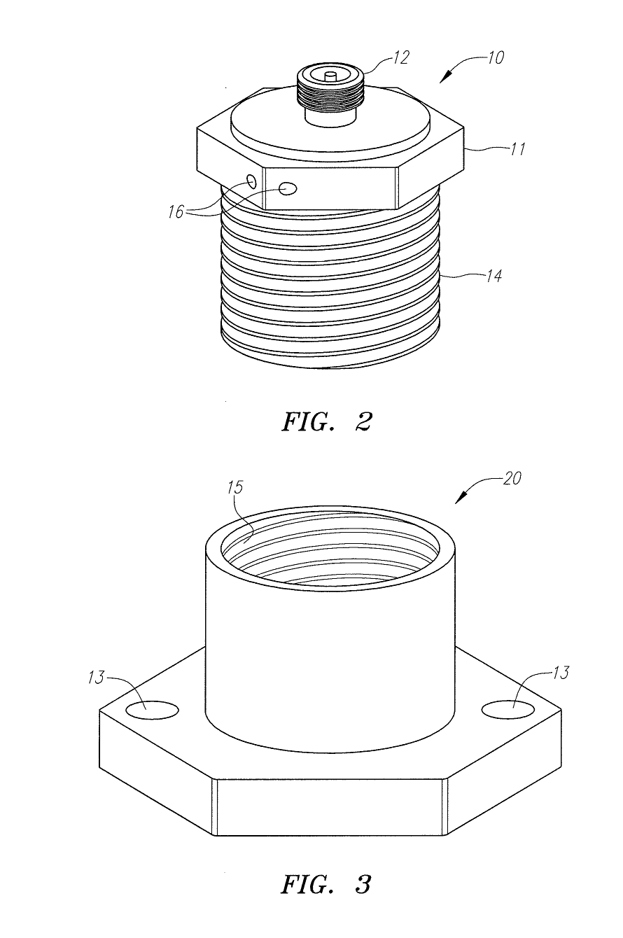

FIG. 2 illustrates an isometric view of another sensor pod 10. The sensor pod 10 shown in FIG. 2 is similar to the sensor pod 10 in FIG. 1 except for the torqueing interface 11 located near the top of the embodiment shown in FIG. 2. The torqueing interface 11 shown in FIG. 2 may be used to allow the sensor pod 10 to be assembled. The torqueing interface 11 may be especially advantageous when the standard sensor interface 14 is threads or another interface that uses torque to allow assembly. In the embodiment shown in FIG. 2, the torqueing interface 11 is a plurality of flat surfaces forming a hexagon around the pod 10. In a preferred embodiment, the torqueing interface 11 is sized to allow the use of conventional torque wrenches. In other embodiments, other types of torqueing interfaces 11 may be used including other shapes and sizes or other types all together. Depending on the embodiment, torqueing interface 11 may be incorporated as part of the housing of the sensor pod 10 or it may be a removable adapter.

In a preferred embodiment, the pod 10 may also contain an interface to support secondary retention 16. In the embodiment shown in FIG. 2, the secondary retention interface 16 is a plurality of holes designed to accommodate a lock wire (not shown). In other embodiments, other types of secondary retention may be used.

FIG. 3 illustrates an isometric view of one embodiment of a mounting adapter 20. A mounting adapter 20 is designed to hold one or more sensor pods 10 and then be assembled to the next higher assembly. Mounting adapter 20 includes a complementary standard interface 15 that mates with the standard sensor interface 14 of the sensor pod 10. The mounting adapter 20 is designed to easily mount to another higher level assembly such as a piece of equipment under test. To this end, mounting adapter 20 may have additional mounting interfaces of its own such as holes 13.

The standard sensor interface 14 of the Pod 10 is designed to mate with the complementary interface 15 or vice versa. In the embodiment of FIG. 3, the complementary standard interface 15 is an internal female thread that accepts the external male thread of standard sensor interface 14 of pod 10. In the embodiment shown in FIG. 3, the complementary standard interface 15 allows the pod 10 to be coupled to the mounting adapter 20 by screwing them together. In general, the complementary standard interface 15 may be any type of interface that mates with the standard sensor interface 14 of the sensor pod 10. As just one example, if the sensor pod 10 has male threads, the complementary standard interface 15 would be the corresponding female threads that mate with the male threads of the sensor pod 10.

In a preferred embodiment, mounting adapter 20 has a mounting interface 13 designed to allow it to be mounted in an upper level assembly. In the embodiment shown in FIG. 13, the mounting interface is a pair of holes; however, in other embodiments the mounting interface 13 may be any other type of interface. For example, mounting adapter 20 may have a threaded hole or threaded shaft on its bottom to allow mounting directly to a higher level assembly.

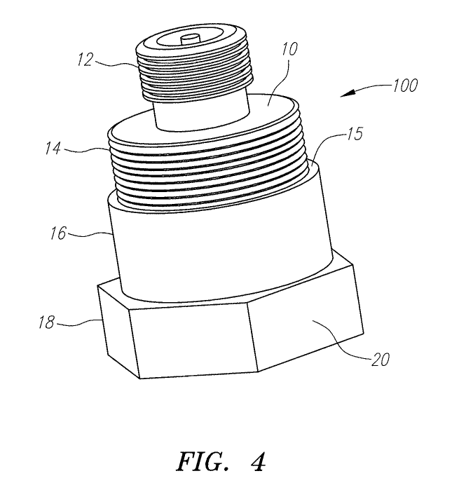

FIG. 4 illustrates an isometric view of one embodiment of a system 100 for installing a piezoelectric sensor comprising a pod 10 and a mounting adapter 20. Mounting adapter 20 includes a complementary interface 15 to the standard sensor interface 14 of the pod 10. As may be seen in FIG. 4, the sensor pod 10 may be assembled to the mounting adapter 20.

Manufacturing is greatly simplified by using the embodiments taught herein. For example, in one embodiment of a method of manufacturing system 100, sensor pods 10 with the identical standard sensor interface 14 are mass produced. Various different mounting adapters are also produced. The different mounting adapters 20 may have various different external interfaces but all the mounting adapters 20 have a complementary standard interface 15. Accordingly, in order to accommodate various different higher level assembly requirements, different embodiments of system 100 may be created by pairing various different sensor pods 10 with one of the various different mounting adapters 20. Additionally the pod and mounting adaptor may be combined with a variety of mounting studs and adhesives for securing to the final structure.

In a preferred embodiment of system 100, various different sensor pods 10 may all be manufactures with the same standard sensor interface 14. The sensors encapsulated in each sensor pod 10 may be very different. The sensors comprising sensor pod 10 may be designed to test for various different things and have various different sensitivities. For example, a sensor pod 10 may embody a sensor designed to measure pressure, temperature, movement, acceleration, gas detection, or any number of other types of qualities. In addition, numerous different output sensitivities may be embodied for each type of sensor. Preferably, the output sensitivities range from 1 to 1000 mV/g. However, in other embodiments, other ranges of sensitivities may be used, including outputs in pC/g. As a non-limiting example, the sensor pod 10 may be available with various output sensitivities ranging from 1, 5, 10, 25, 50, 100, 500, and 1000 mV/g.

In some embodiments, the sensor pod 10 may accommodate an Integral Electronic Piezoelectric (IEPE) sensor design. In IEPE embodiments of the sensor pod 10, the transducer is packaged with a built-in charge amplifier or voltage amplifier. Because in IEPE sensors pods the charge produced by the transducer is typically very small, the electrical signal produced is susceptible to noise, and sensitive electronics must be used to amplify and condition the signal. In embodiments using an IEPE design, the sensitive electronics may be packaged as close as possible to the transducer and may be located in the sensor pod 10 to ensure better noise immunity and more convenient packaging.

In other embodiments, the sensor pod 10 may accommodate a Piezoelectric (PE) sensor design, and/or a sensor with or without internal signal conditioning. Accordingly, a completely modular system 100 is created in which numerous different types of sensors may be easily adapted with various different types of mounting adapters 20, such that they may easily be installed in various different higher level assemblies.

Although the embodiment shown in FIG. 1 includes a single standard interface 14 that is threaded, other embodiments of the sensor pod 10 may have any number of standard interfaces 14. In a preferred embodiment, sensor pod 10 has only a single standard interface. In addition, the standard interfaces are not limited to threads. In other embodiments, other types of standard interfaces may be used, such as press fit, snap fit, tongue and groove, or any other type of fastening interface. Moreover, the interface on the sensor pod 10 may be male or female with the corresponding interface on the mounting adapter 20 being the complimentary interface.

In various different embodiments, the mounting adapter 20 may also take on various different configurations. In the preferred embodiment, the mounting adapter always includes at least one complementary standard interface 15. In addition to the complementary standard interface 15, the mounting adapter 20 may include any number of other interfaces. In the embodiment shown in FIG. 3, the mounting adapter 20 includes holes 13. However, in other embodiments, mounting adapter 20 may include other types of interfaces, including press fit, slip fit, tongue and groove, Velcro, glue, nut, bolt, thread, spike, screw, hole, groove, or any other type of interface. Mounting adapter 20 may include any type of interface to facilitate assembly to the next level assembly.

Mounting adapter 20 may further include any type of tool interface necessary to make installing the system 100 easier or installing the sensor pod 10 into the mounting adapter 20 easier. As shown in FIG. 4, mounting adapter 20 includes a hexagonal structure to allow it to easily interface with a standard wrench. A standard wrench may tighten the hex on the sensor pod 10 into the mounting adapter 20 or a torque tool may be provided with the sensor kit. In yet other embodiments, mounting adapter 20 may have other types of interfaces that allow mounting adapter 20 to be easily installed with any type of tool. As just one example, mounting adapter 20 may have a screw driver interface.

In a preferred embodiment, both the external case of sensor pod 10 and mounting adapter 20 are made from metal, for example, stainless steel. As is well known in the art, the materials and processing of both the sensor pod 10 and mounting adapter 20 should be selected to make sure the interfaces work together appropriately.

Although in a preferred embodiment, both the sensor pod 10 and mounting adapter 20 are made from metal, many other materials or combinations of materials may be used. Materials such as plastic, rubber, and ceramic may be used or incorporated, just to name a few. In addition, combinations of materials may also be used to construct either the sensor pods 10 or the mounting adapters 20.

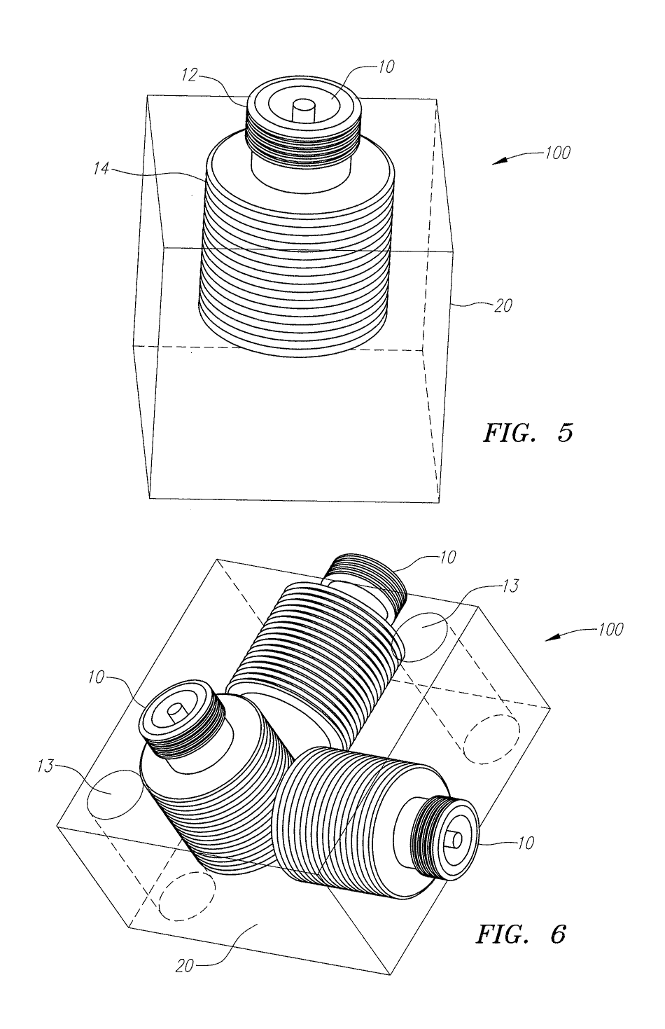

FIG. 5 illustrates an isometric view of one embodiment of a system 100 for installing a piezoelectric sensor comprising a pod 10 and a mounting adapter 20. In the embodiment shown in FIG. 5, the sensor pod 10 is installed in a mounting adapter 20 that is shaped like a block. Similar to the mounting adapters 20 in FIGS. 3 and 4, the mounting adapter 20 in FIG. 5 includes a complementary standard interface 15 that mates with the standard interface on the outside of sensor pod 10. As a non-limiting example, the complementary standard interface 15 may be female ½-UNF-2A threads. The mounting adapter 20 may be mounted at the next higher level with various threaded studs or adhesives. Other interfaces may be used in other embodiments.

Mounting sensor pod 10 into a block shaped mounting adapter 20 allows the sensor assembly system 100 to be mounted into a higher level assembly designed to receive a block shaped sensor assembly, usually by glue or epoxy. To this end, the sensor pod 10 may be adapted to traditional mounting configurations by threading the sensor pod into shapes like blocks or other traditional shapes. Shapes of the mounting adapter 20 may include a hex base, isolated or non-isolated, a cube, isolated or non-isolated, and may be adapted into an isolated triaxial cube, to name but a few.

In some embodiments, mounting adapter 20 may be designed to hold more than one sensor pod 10. FIG. 6 illustrates an isometric view of one embodiment of a sensor system 100 including a mounting adapter 20 designed to hold multiple sensor pods 10. As may be seen in FIG. 6, three sensor pods 10 are installed in mounting adapter 20. Mounting adapter 20 includes three complementary standard interfaces 15 that allow sensor pods 10 to easily be installed. In other embodiments, mounting adapter 20 may be designed to hold more than three or less than three sensor pods 10. In addition to the complementary standard interfaces 15, mounting adapter 20 includes mounting interface 13 to allow the sensor system 100 to be easily mounted into the next higher assembly.

The mounting adapter 20 may also be designed to arrange the sensor pods 10 in a specific configuration. For example, as shown in FIG. 6, each sensor pod 10 may be mounted on one of the three axes of mounting adapter 20. When dealing with sensor pods 10 that are designed to detect acceleration, mounting on the three axes allows each detector to be dedicated to a specific axis.

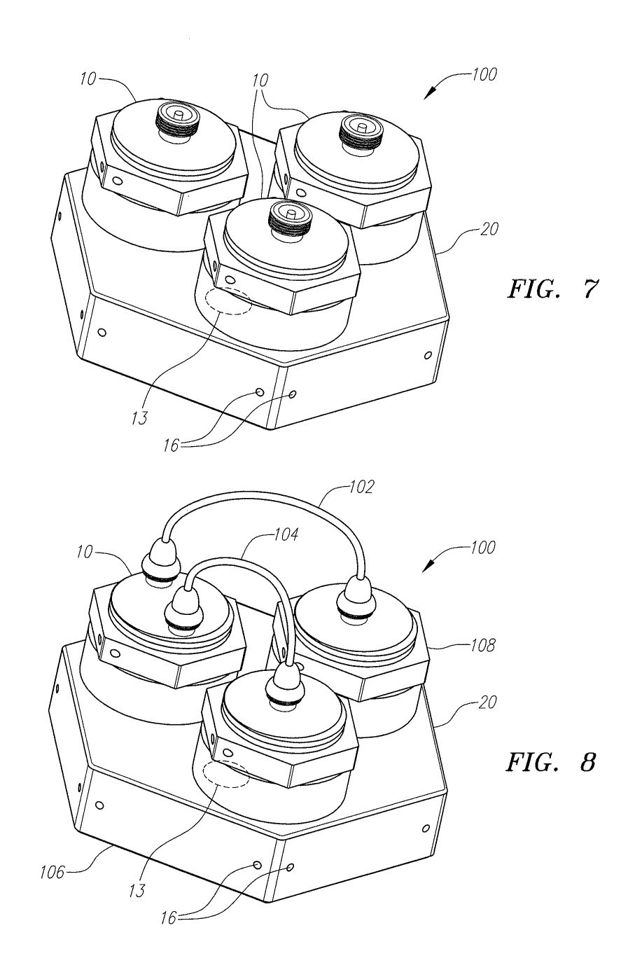

In addition to allowing a specific sensor to be dedicated to a specific axis, having multiple sensor pods 10 mounted in a single mounting adapter 20 allows for sensors of different sensitivities to be mounted together. FIG. 7 illustrates a system 100 with a plurality of sensor pods 10 mounted in a mounting adapter 20 along the same axis. In some embodiments such as the one shown in FIG. 7, sensor pods 10 with varying sensitivities may be mounted within one mounting adapter 20 for tailoring to more specific needs, such as in vibration sensing. While the embodiment in FIG. 7, illustrates sensors pods 10 aligned along the same axis with different sensitivities, in other embodiments, sensors with different sensitivities may be used along different axes.

Mounting adapter 20 may also include additional features to allow the sensor pods 10 to function in specific environments. For example, the mounting adapter 20 may include shock absorbing material to allow the sensor system 100 to survive and operate in high shock environments. In one embodiment, mounting adapter 20 may include a shock absorbing material between the sensor pod 10 and the mounting adapter 20. In another embodiment, mounting adapter 20 may include a shock absorbing material approximate to the external mounting interface, embodied as holes 13 in FIG. 4, such that the shock absorbing material is between the sensor system 100 and whatever it is assembled to.

As another example of an additional feature to allow the sensor pods 10 to function in specific environments, the mounting adapter 20 may include thermal mitigation components. Certain sensors may need to be thermally managed, either actively or passively. In such embodiments, the mounting adapter 20 may include such active or passive thermal mitigation components. As just one example, mounting adapter 20 may have thermal insulation material between the installed sensor pods 10 and the mounting adapter 20. Such a configuration would help reduce heat from transferring through the mounting adapter to the sensor pods 10.

Manufacturing various different types of sensors to support different installations is simplified under the methods of the present patent document. A sensor pod may be identically produced in large quantities with the same standard sensor interface. In some embodiments, different sensors may even be produced, provided that they all include at least one standard sensor interface. The mounting adapters may then be manufactured according to need. If a new external interface needs to be supported, a costly new sensor design is not needed, only a new mounting adapter. Generally speaking, the external mounting and design requirements have been divorced from the design of the sensor under methods of the present patent document which include: manufacturing a plurality of sensor pods each with the same standard sensor interface; and manufacturing a plurality of mounting adapters with different external interfaces but each with a complementary standard interface.

The systems 100 include versatile threaded housings and may provide a number of benefits, including but not limited to: (i) allowing for all pod sensitivities to be assembled and tested prior to final customer packaging requirements, due to modular/interchangeable pods allowed within the product line; (ii) allowing various sensitivity pods within one sensor for tailoring to more specific vibration needs; and (iii) allowing the customer to create the accelerometer mounting needed for a particular vibration environment by threading into a different style base. The sensor pods of the present patent document may achieve the desired overall technical performance features, including but not limited to noise levels, sensitivities, resonances, and the like, in a globally optimized pod package.

While the above describes the use of sensors designed with a standard sensor interface 14, other components could also be designed with the same standard interface such that they may be installed into the mounting adapters 20. For example, in addition to different types of sensors with different sensitivities, components such as a data acquisition module (DAQ), battery, energy harvester, power supply, power connection, battery charger, data logger, communications link (wired, wireless, optical, etc.), signal conditioners, isolation circuits, line drivers, alert indicator, alarm relay, and/or any other type of component. These components may be mixed and matched with various different sensors in mounting adapters to create assemblies with different capabilities.

FIG. 8 illustrates a system with a mounting adapter with diverse components mounted to it. In FIG. 8, a sensor pod 10 is mounted in combination with a DAQ 106 and a battery 108. All three components include a standard sensor interface 14 and are mounted to the mounting adapter 20. As may be seen in FIG. 8, the components may be electrically connected to each other via electrical cables 102 and 104. In other embodiments, other mounting adapters 20 may be used and different combinations of components may be assembled.

Although the inventions have been described with reference to preferred embodiments and specific examples, it will readily be appreciated by those skilled in the art that many modifications and adaptations of the methods and devices described herein are possible without departure from the spirit and scope of the inventions as claimed hereinafter. Thus, it is to be clearly understood that this description is made only by way of example and not as a limitation on the scope of the inventions as claimed below.

What is claimed is:

1. A system for installing a piezoelectric sensor, the system comprising:
a sensor pod including at least one standard sensor interface; and
a plurality of different mounting adapters that include different external mounting interfaces, wherein each mounting adapter has at least one complementary standard sensor interface.

2. The system of claim 1, further comprising a plurality of sensor pods with the same standard sensor interface wherein different sensor pods are capable of measuring different output sensitivities.

3. The system of claim 2, wherein the output sensitivities range from 1 to 1000 mV/g.

4. The system of claim 1, wherein at least one of the mounting adapters is shaped like a block.

5. The system of claim 1, wherein at least one of the mounting adapters has a hexagonal interface.

6. The system of claim 1, wherein at least one of the mounting adapters is designed to hold more than one sensor pod.

7. The system of claim 6, wherein at least one of the mounting adapters is designed to hold three sensor pods in a triaxial configuration.

8. The system of claim 1, wherein the sensor pod includes a transducer and signal conditioning electronics.

9. The system of claim 8, wherein the sensor pod has an IEPE sensor design.

10. A modular system of piezoelectric sensors, the system comprising:
a plurality of sensor pods with varying sensitivities wherein each sensor pod includes at least one standard sensor interface; and
a mounting adapter with an external mounting interface and at least one complementary standard sensor interface.

11. The system of claim 10, further comprising a plurality of different mounting adapters that include different external mounting interfaces wherein each mounting adapter has at least one complementary standard sensor interface.

12. The system of claim 10, wherein the output sensitivities range from 1 to 1000 mV/g.

13. The system of claim 10, wherein the output sensitivities range from 1 to 25 pC/g.

14. The system of claim 10, wherein the mounting adapter has a hexagonal external interface.

15. The system of claim 10, wherein the mounting adapter is designed to hold more than one sensor pod.

16. The system of claim 15, wherein the mounting adapter is designed to hold three sensor pods in a triaxial configuration.

17. The system of claim 10, wherein the sensor pod includes a transducer and signal conditioning electronics.

18. A method of providing a plurality of piezoelectric sensors with different mounting interfaces comprising:
manufacturing a plurality of sensor pods each with the same standard sensor interface; and
manufacturing a plurality of mounting adapters with different external interfaces but each with a complementary standard sensor interface.

19. The method of claim 18, wherein the plurality of sensor pods includes sensor pods with varying sensitivities.

20. The method of claim 18, wherein the plurality of sensor pods includes sensor pods designed to detect different measurable effects.
